(19) United States
(12) Patent Application Publication
(10) Pub. No.: US 2025/0308450 A1
(43) Pub. Date: Oct. 2, 2025

(54) PIXEL AND DISPLAY DEVICE INCLUDING THE SAME

(71) Applicant: Samsung Display Co., LTD., Yongin-si (KR)

(72) Inventors: Byungchang YU, Yongin-si (KR); Jangmi KANG, Yongin-si (KR); Minkyu WOO, Yongin-si (KR); Geunho LEE, Yongin-si (KR)

(73) Assignee: Samsung Display Co., LTD., Yongin-si (KR)

(21) Appl. No.: 19/017,018

(22) Filed: Jan. 10, 2025

(30) Foreign Application Priority Data
Apr. 1, 2024 (KR) 10-2024-0043926

(51) Int. Cl. G09G 3/3233; G09G 3/20

(52) U.S. Cl. CPC G09G 3/3233; G09G 3/2092; G09G 2300/0842; G09G 2310/066; G09G 2310/08; G09G 2320/0242; G09G 2320/0666

(57) ABSTRACT

Provided is a pixel including a first sub-pixel which displays a first color, and a second sub-pixel which displays a second color. Each of the first sub-pixel and the second sub-pixel includes a light-emitting element through which a driving current flows and a pulse width modulator which controls a width of the driving current. The first sub-pixel and the second sub-pixel share a pulse amplitude modulator which controls an amplitude of the driving current.

### CROSS-REFERENCE TO RELATED APPLICATION(S)

This application claims priority to and benefits of Korean Patent Application No. 10-2024-0043926 filed on Apr. 1, 2024 under 35 U.S.C. § 119, in the Korean Intellectual Property Office, the entire disclosure of which is incorporated herein by reference.

### BACKGROUND

### 1. Technical Field

The disclosure generally relates to a display device. More particularly, the disclosure relates to a pixel including sub-pixels and a display device including the pixel.

### 2. Description of the Related Art

Multiple pixels may be present in a display device in order to display an image. Each of the pixels may include a plurality of sub-pixels that display different colors.

In order for the pixel to display accurate and uniform color, the number of components (e.g., transistors, capacitors, etc.) included in the pixel may increase. When the number of components included in the pixel increases, the size of the pixel may increase, but increasing the resolution of the display device may be limited.

### SUMMARY

Embodiments provide a pixel with a reduced size.

Embodiments provide a display device with an increased resolution.

A pixel according to embodiments may include a first sub-pixel which displays a first color and a second sub-pixel which displays a second color. Each of the first sub-pixel and the second sub-pixel may include a light-emitting element through which a driving current flows and a pulse width modulator which controls a width of the driving current. The first sub-pixel and the second sub-pixel may share a pulse amplitude modulator which controls an amplitude of the driving current.

A frame period may include a first sub-frame period and a second sub-frame period. The first sub-pixel may display the first color in the first sub-frame period, and the second sub-pixel may display the second color in the second sub-frame period.

A first data voltage may be applied to the pulse width modulator of the first sub-pixel in the first sub-frame period, and a second data voltage may be applied to the pulse width modulator of the second sub-pixel in the second sub-frame period.

The pulse width modulator may include a first transistor including a gate to receive a scan signal, a first terminal to receive a data voltage, and a second terminal electrically connected to a first node, a capacitor including a first terminal to receive a sweep signal and a second terminal electrically connected to the first node, a second transistor including a gate electrically connected to a second node, a first terminal electrically connected to the pulse amplitude modulator, and a second terminal electrically connected to the light-emitting element, and an inverter electrically connected between the first node and the second node.

The pulse amplitude modulator may include a current source.

The pulse amplitude modulator may be electrically connected to a line which transmits a high power voltage, the light-emitting element may be electrically connected to a line which transmits a low power voltage, and the pulse width modulator may be electrically connected between the pulse amplitude modulator and the light-emitting element.

The light-emitting element may be electrically connected to a line which transmits a high power voltage, the pulse amplitude modulator may be electrically connected to a line which transmits a low power voltage, and the pulse width modulator may be electrically connected between the light-emitting element and the pulse amplitude modulator.

The pixel may further include a third sub-pixel which displays a third color and includes the light-emitting element and the pulse width modulator. The first sub-pixel, the second sub-pixel, and the third sub-pixel may share the pulse amplitude modulator.

A frame period may include a first sub-frame period, a second sub-frame period, and a third sub-frame period. The first sub-pixel may display the first color in the first sub-frame period, the second sub-pixel may display the second color in the second sub-frame period, and the third sub-pixel may display the third color in the third sub-frame period.

A first data voltage may be applied to the pulse width modulator of the first sub-pixel in the first sub-frame period, a second data voltage may be applied to the pulse width modulator of the second sub-pixel in the second sub-frame period, and a third data voltage may be applied to the pulse width modulator of the third sub-pixel in the third sub-frame period.

A pixel according to embodiments may include a first sub-pixel which displays a first color and a second sub-pixel which displays a second color. Each of the first sub-pixel and the second sub-pixel may include a light-emitting element through which a driving current flows and a transistor which controls a width of the driving current in response to an emission signal. The first sub-pixel and the second sub-pixel may share a pulse amplitude modulator which controls an amplitude of the driving current.

A frame period may include a first sub-frame period and a second sub-frame period. The first sub-pixel may display the first color in the first sub-frame period, and the second sub-pixel may display the second color in the second sub-frame period.

A first data voltage may be applied to the pulse amplitude modulator in the first sub-frame period, and a second data voltage may be applied to the pulse amplitude modulator in the second sub-frame period.

The transistor may include a gate to receive the emission signal, a first terminal electrically connected to the pulse amplitude modulator, and a second terminal electrically connected to the light-emitting element.

The pulse amplitude modulator may be electrically connected to a line which transmits a high power voltage, the light-emitting element may be electrically connected to a line which transmits a low power voltage, and the transistor may be electrically connected between the pulse amplitude modulator and the light-emitting element.

The light-emitting element may be electrically connected to a line which transmits a high power voltage, the pulse amplitude modulator may be electrically connected to a line which transmits a low power voltage, and the transistor may be electrically connected between the light-emitting element and the pulse amplitude modulator.

A display device according to embodiments may include a plurality of pixels, each of the plurality of pixels including a first sub-pixel which displays a first color and a second sub-pixel which displays a second color. Each of the first sub-pixel and the second sub-pixel may include a light-emitting element through which a driving current flows and a pulse width modulator which controls a width of the driving current. The first sub-pixel and the second sub-pixel may share a same pulse amplitude modulator which controls an amplitude of the driving current.

A frame period may include a first sub-frame period and a second sub-frame period. The first sub-pixel may display the first color in the first sub-frame period, and the second sub-pixel may display the second color in the second sub-frame period.

A first data voltage may be applied to the pulse width modulator of the first sub-pixel in the first sub-frame period, and a second data voltage may be applied to the pulse width modulator of the second sub-pixel in the second sub-frame period.

The pulse width modulator may include a first transistor including a gate to receive a scan signal, a first terminal to receive a data voltage, and a second terminal electrically connected to a first node, a capacitor including a first terminal to receive a sweep signal and a second terminal electrically connected to the first node, a second transistor including a gate electrically connected to a second node, a first terminal electrically connected to the pulse amplitude modulator, and a second terminal electrically connected to the light-emitting element, and an inverter electrically connected between the first node and the second node.

In the pixel according to the embodiments, the sub-pixels included in the pixel may share the pulse amplitude modulator, so that the size of the pixel may be reduced. Further, in the display device according to embodiments, the sizes of the pixels included in the display device may be reduced, so that the resolution of the display device may increase.

### BRIEF DESCRIPTION OF THE DRAWINGS

Illustrative, non-limiting embodiments will be more clearly understood from the following detailed description taken in conjunction with the accompanying drawings.

FIG. 1 is a schematic block diagram illustrating a display device according to an embodiment.

FIG. 2 is a schematic view illustrating an example of a pixel included in the display device of FIG. 1.

FIG. 3 is a schematic view illustrating a driving current flowing through a light-emitting element of a sub-pixel included in the pixel of FIG. 2.

FIG. 4 is a schematic view for describing an operation of the pixel of FIG. 2.

FIG. 5 is a schematic circuit diagram illustrating an example of a sub-pixel included in the pixel of FIG. 2.

FIG. 6 is a schematic view for describing an operation of the sub-pixel of FIG. 5.

FIG. 7 is a schematic view illustrating a pixel according to an embodiment.

FIG. 8 is a schematic view illustrating pixels according to an embodiment.

FIG. 9 is a schematic view for describing operations of the pixels of FIG. 8.

FIG. 10 is a schematic view illustrating a pixel according to an embodiment.

FIG. 11 is a schematic view for describing an operation of the pixel of FIG. 10.

FIG. 12 is a schematic view illustrating a pixel according to an embodiment.

FIG. 13 is a schematic view illustrating pixels according to an embodiment.

FIG. 14 is a schematic view for describing operations of the pixels of FIG. 13.

FIG. 15 is a schematic block diagram illustrating an electronic apparatus according to an embodiment.

FIG. 16 is a schematic view illustrating an example in which the electronic apparatus of FIG. 15 is implemented as a smart watch.

### DETAILED DESCRIPTION OF THE EMBODIMENTS

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing exemplary features of the invention. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals and/or reference characters denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the X-axis, the Y-axis, and the Z-axis are not limited to three axes of a rectangular coordinate system, such as the x, y, and z axes, and may be interpreted in a broader sense. For example, the X-axis, the Y-axis, and the Z-axis may be perpendicular to one another, or may represent different directions that are not perpendicular to one another. For the purposes of this disclosure, “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

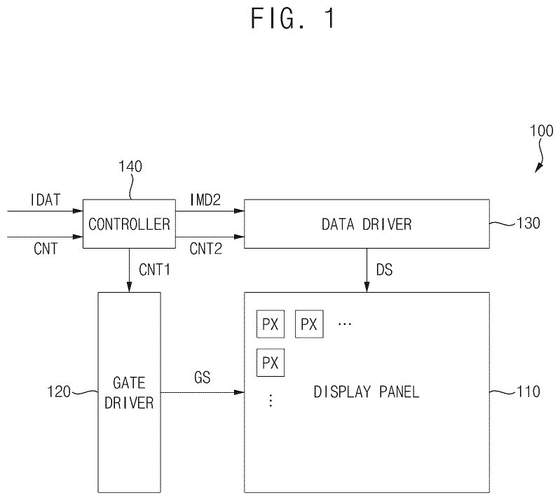

FIG. 1 is a schematic block diagram illustrating a display device 100 according to an embodiment.

Referring to FIG. 1, a display device 100 may include a display panel 110, a gate driver 120, a data driver 130, and a controller 140.

The display panel 110 may include multiple pixels PX. Each of the pixels PX may include multiple sub-pixels.

The gate driver 120 may provide gate signals GS to the display panel 110. The gate driver 120 may generate the gate signals GS based on a first control signal CNT1 generated from the controller 140. The first control signal CNT1 may include a gate clock signal, a gate start signal, etc.

The data driver 130 may provide data signals DS to the display panel 110. The data driver 130 may generate the data signals DS based on second image data IMD2 and a second control signal CNT2 generated from the controller 140. The second control signal CNT2 may include a data clock signal, a load signal, etc. The data driver 130 may convert the second image data IMD2 in a digital form into the data signals DS in an analog form.

The controller 140 may control an operation (or driving) of the gate driver 120 and an operation (or driving) of the data driver 130. The controller 140 may provide the first control signal CNT1 to the gate driver 120, and may provide the second image data IMD2 and the second control signal CNT2 to the data driver 130. The controller 140 may generate the first control signal CNT1, the second image data IMD2, and the second control signal CNT2 based on a first image data IDAT and a control signal CNT which may be generated from an external source. The controller 140 may compensate for the first image data IDAT to generate the second image data IMD2.

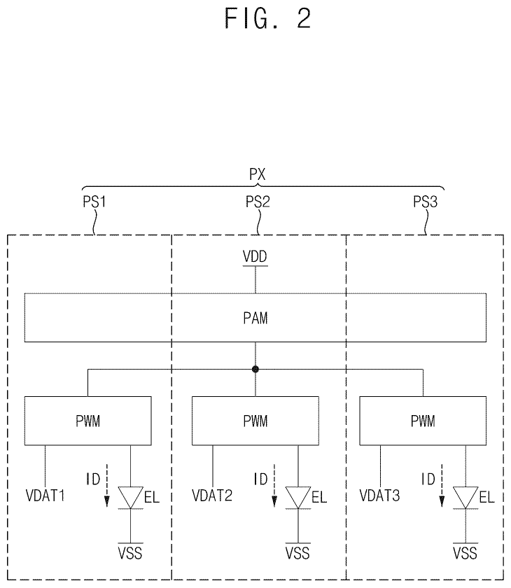

FIG. 2 is a schematic view illustrating an example of the pixel PX included in the display device 100 of FIG. 1. FIG. 3 is a schematic view illustrating a driving current ID flowing through a light-emitting element EL of a sub-pixel included in the pixel PX of FIG. 2.

Referring to FIGS. 2 and 3, the pixel PX may include a first sub-pixel PS1, a second sub-pixel PS2, and a third sub-pixel PS3. The first sub-pixel PS1, the second sub-pixel PS2, and the third sub-pixel PS3 may display a first color, a second color, and a third color, respectively. The pixel PX may display one color by combining the first color displayed by the first sub-pixel PS1, the second color displayed by the second sub-pixel PS2, and the third color displayed by the third sub-pixel PS3.

The first color, the second color, and the third color may emit a red color, a green color, and a blue color, respectively. In another embodiment, the first color, the second color, and the third color may emit a cyan color, a magenta color, and a yellow color, respectively.

Each of the first sub-pixel PS1, the second sub-pixel PS2, and the third sub-pixel PS3 may include a light-emitting element EL and a pulse width modulator PWM.

A driving current ID may flow through the light-emitting element EL. For example, the driving current ID may flow from the pulse width modulator PWM to the light-emitting element EL. The light-emitting element EL may emit light having a luminance LUM corresponding to the driving current ID. The luminance LUM of the light emitted from the light-emitting element EL may correspond to a product of a width W_ID of the driving current ID and an amplitude A_ID of the driving current ID as shown in FIG. 3. Accordingly, the luminance LUM of the light emitted from the light-emitting element EL may be controlled by changing the width W_ID and the amplitude A_ID of the driving current ID.

The light-emitting element EL may be a micro light-emitting diode (μLED). The micro light-emitting diode may refer to an ultra-small light-emitting diode having a size of about 100 μm or less. In another embodiment, the light-emitting element EL may be an organic light-emitting diode (OLED). In another embodiment, the light-emitting element EL may be one of a nano light-emitting diode (NED), a quantum dot light-emitting diode, and an inorganic light-emitting diode.

The pulse width modulator PWM may control the width W_ID of the driving current ID. The pulse width modulator PWM may receive a data voltage for controlling the width W_ID of the driving current ID. The pulse width modulator PWM of the first sub-pixel PS1 may receive a first data voltage VDAT1, the pulse width modulator PWM of the second sub-pixel PS2 may receive a second data voltage VDAT2, and the pulse width modulator PWM of the third sub-pixel PS3 may receive a third data voltage VDAT3. The data signal DS of FIG. 1 may include the first data voltage VDAT1, the second data voltage VDAT2, and the third data voltage VDAT3.

The first sub-pixel PS1, the second sub-pixel PS2, and the third sub-pixel PS3 may share a pulse amplitude modulator PAM such as a same pulse amplitude modulator or a single pulse amplitude modulator. For example, the pixel PX may include one pulse amplitude modulator PAM electrically connected to each of the pulse width modulators PWM. The pulse amplitude modulator PAM may control the amplitude A_ID of the driving current ID.

The pulse amplitude modulator PAM may be electrically connected to a line transmitting a high power voltage VDD, the light-emitting element EL may be electrically connected to a line transmitting a low power voltage VSS, and the pulse width modulator PWM may be electrically connected between the pulse amplitude modulator PAM and the light-emitting element EL. A voltage level of the high power voltage VDD may be higher than a voltage level of the low power voltage VSS so that the driving current ID may flow from the high power voltage VDD to the low power voltage VSS.

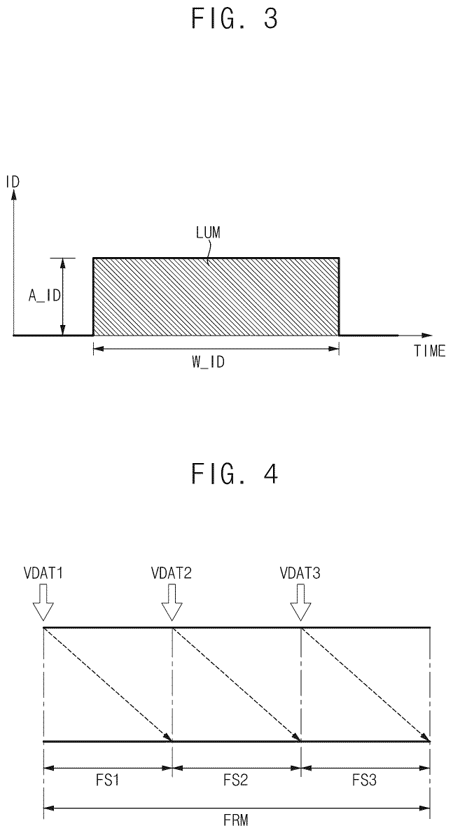

FIG. 4 is a schematic view for describing an operation of the pixel PX of FIG. 2.

Referring to FIGS. 2 to 4, a frame period FRM may include a first sub-frame period FS1, a second sub-frame period FS2, and a third sub-frame period FS3. The first sub-pixel PS1 may display the first color in the first sub-frame period FS1, the second sub-pixel PS2 may display the second color in the second sub-frame period FS2, and the third sub-pixel PS3 may display the third color in the third sub-frame period FS3.

The first data voltage VDAT1 may be applied to the pulse width modulator PWM of the first sub-pixel PS1 in the first sub-frame period FS1, the second data voltage VDAT2 may be applied to the pulse width modulator PWM of the second sub-pixel PS2 in the second sub-frame period FS2, and the third data voltage VDAT3 may be applied to the pulse width modulator PWM of the third sub-pixel PS3 in the third sub-frame period FS3. Accordingly, a driving current ID having a width W_ID corresponding to the first data voltage VDAT1 may flow through the light-emitting element EL of the first sub-pixel PS1 in the first sub-frame period FS1, a driving current ID having a width W_ID corresponding to the second data voltage VDAT2 may flow through the light-emitting element EL of the second sub-pixel PS2 in the second sub-frame period FS2, and a driving current ID having a width W_ID corresponding to the third data voltage VDAT3 may flow through the light-emitting element EL of the third sub-pixel PS3 in the third sub-frame period FS3.

The pulse amplitude modulator PAM may control the amplitude A_ID of the driving current ID to be substantially equal in each of the first sub-frame period FS1, the second sub-frame period FS2, and the third sub-frame period FS3. For example, an amplitude A_ID of the driving current ID flowing through the light-emitting element EL of the first sub-pixel PS1 in the first sub-frame period FS1, an amplitude A_ID of the driving current ID flowing through the light-emitting element EL of the second sub-pixel PS2 in the second sub-frame period FS2, and an amplitude A_ID of the driving current ID flowing through the light-emitting element EL of the third sub-pixel PS3 in the third sub-frame period FS3 may be substantially equal to each other.

In another embodiment, the pulse amplitude modulator PAM may control the amplitude A_ID of the driving current ID differently in each of the first sub-frame period FS1, the second sub-frame period FS2, and the third sub-frame period FS3. For example, the pulse amplitude modulator PAM may control the amplitude A_ID of the driving current ID differently in each of the first sub-frame period FS1, the second sub-frame period FS2, and the third sub-frame period FS3 in consideration of characteristics of the light-emitting element EL (e.g., a red light-emitting element) of the first sub-pixel PS1, the light-emitting element EL (e.g., a green light-emitting element) of the second sub-pixel PS2, and the light-emitting element EL (e.g., a blue light-emitting element) of the third sub-pixel PS3. For example, an amplitude A_ID of the driving current ID flowing through the light-emitting element EL of the first sub-pixel PS1 in the first sub-frame period FS1, an amplitude A_ID of the driving current ID flowing through the light-emitting element EL of the second sub-pixel PS2 in the second sub-frame period FS2, and an amplitude A_ID of the driving current ID flowing through the light-emitting element EL of the third sub-pixel PS3 in the third sub-frame period FS3 may be different from each other.

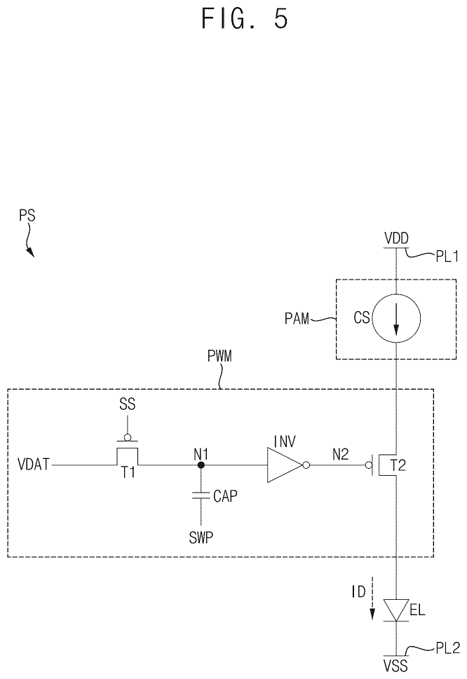

FIG. 5 is a schematic circuit diagram illustrating an example of a sub-pixel PS included in the pixel PX of FIG. 2. The sub-pixel PS of FIG. 5 may be one of the first to third sub-pixels PS1, PS2, and PS3 included in the pixel PX of FIG. 2.

Referring to FIG. 5, the sub-pixel PS may include a light-emitting element EL, a pulse width modulator PWM, and a pulse amplitude modulator PAM. For example, an end of the pulse width modulator PWM may be electrically connected to the pulse amplitude modulator PAM and another end of the pulse width modulator PWM may be electrically connected to the light-emitting element EL. Furthermore, the pulse amplitude modulator PAM may be electrically connected to the first power line PL1, and the light-emitting element EL may be electrically connected to the second power line PL2. However, the configuration of these components is not limited thereto.

The light-emitting element EL may include a first terminal electrically connected to the pulse width modulator PWM and a second terminal electrically connected to a second power line PL2 that transmits the low power voltage VSS. A driving current ID may flow through the light-emitting element EL, and the light-emitting element EL may emit light having a luminance corresponding to the driving current ID.

The pulse width modulator PWM may include a first transistor T1, a capacitor CAP, a second transistor T2, and an inverter INV. However, in another embodiment, the pulse width modulator PWM may include other components for controlling the width of the driving current ID.

The first transistor T1 may include a gate receiving a scan signal SS, a first terminal receiving a data voltage VDAT, and a second terminal electrically connected to a first node N1. The gate signal GS of FIG. 1 may include the scan signal SS. The first transistor T1 may transmit the data voltage VDAT to the first node N1 in response to the scan signal SS.

The capacitor CAP may include a first terminal receiving a sweep signal SWP and a second terminal electrically connected to the first node N1. The capacitor CAP may store a voltage of the first node N1.

The second transistor T2 may include a gate electrically connected to a second node N2, a first terminal electrically connected to the pulse amplitude modulator PAM, and a second terminal electrically connected to the first terminal of the light-emitting element EL. The second transistor T2 may transmit the driving current ID generated by the pulse amplitude modulator PAM to the light-emitting element EL in response to a voltage of the second node N2.

The inverter INV may be electrically connected between the first node N1 and the second node N2. The inverter INV may invert the voltage of the first node N1 and output the inverted voltage to the second node N2.

The pulse amplitude modulator PAM may include a current source CS. However, in another embodiment, the pulse amplitude modulator PAM may include a different component for controlling the amplitude of the driving current ID.

The current source CS may be electrically connected between a first power line PL1 that transmits the high power voltage VDD and the first terminal of the second transistor T2. The current source CS may generate the driving current ID having a constant amplitude.

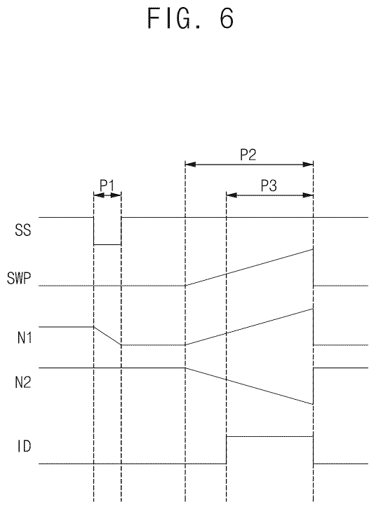

FIG. 6 is a schematic view for describing an operation of the sub-pixel PS of FIG. 5.

Referring to FIGS. 5 and 6, in a first period P1, the first transistor T1 may be turned on in response to the scan signal SS having a turn-on voltage level, and the data voltage VDAT may be applied to the first node N1.

In the second period P2, the sweep signal SWP may linearly increase from a low voltage level to a high voltage level, and the voltage of the first node N1 may linearly increase in response to the sweep signal SWP due to a coupling effect by the capacitor CAP. The voltage of the second node N2 may linearly decrease in contrast to the voltage of the first node N1 by the inverter INV.

In a third period P3 in which the voltage of the second node N2 has a turn-on voltage level at which the second transistor T2 is turned on, the second transistor T2 may be turned on in response to the voltage of the second node N2, and the driving current ID generated from the current source CS may flow through the light-emitting element EL via the turned-on second transistor T2.

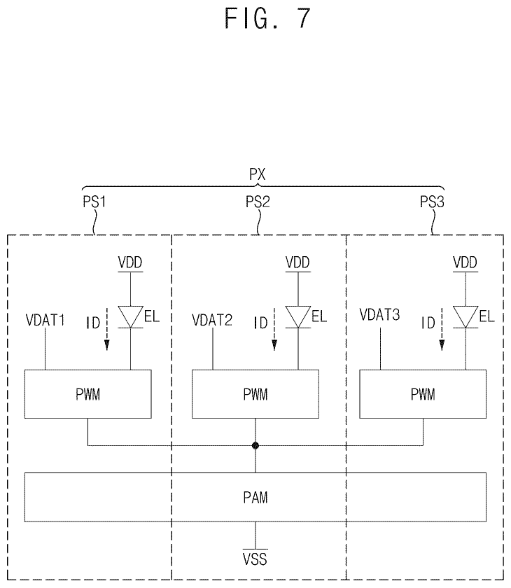

FIG. 7 is a schematic view illustrating a pixel PX according to an embodiment.

Descriptions of components of the pixel PX described with reference to FIG. 7, which are substantially the same as or similar to those of the pixel PX described with reference to FIG. 2, will be omitted.

Referring to FIG. 7, each of the light-emitting elements EL may be electrically connected to a line transmitting the high power voltage VDD respectively, the pulse amplitude modulator PAM may be electrically connected to a line transmitting the low power voltage VSS, and the pulse width modulator PWM may be electrically connected between the light-emitting element EL and the pulse amplitude modulator PAM.

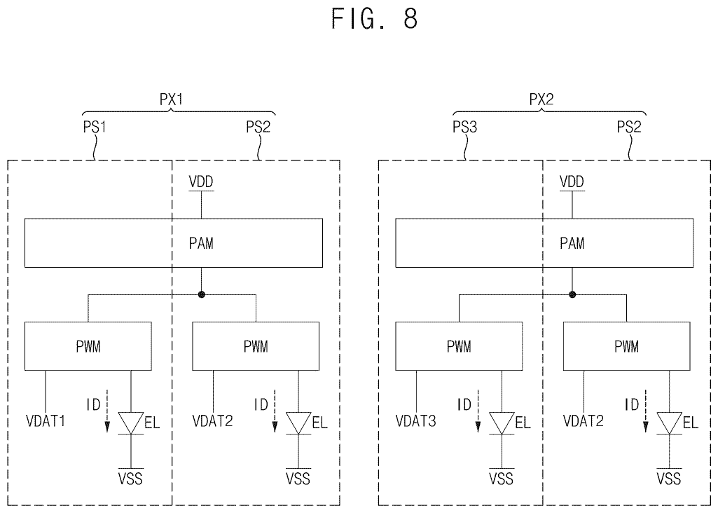

FIG. 8 is a schematic view illustrating pixels PX1 and PX2 according to an embodiment.

Descriptions of components of the pixels PX1 and PX2 described with reference to FIG. 8, which are substantially the same as or similar to those of the pixel PX described with reference to FIG. 2, will be omitted.

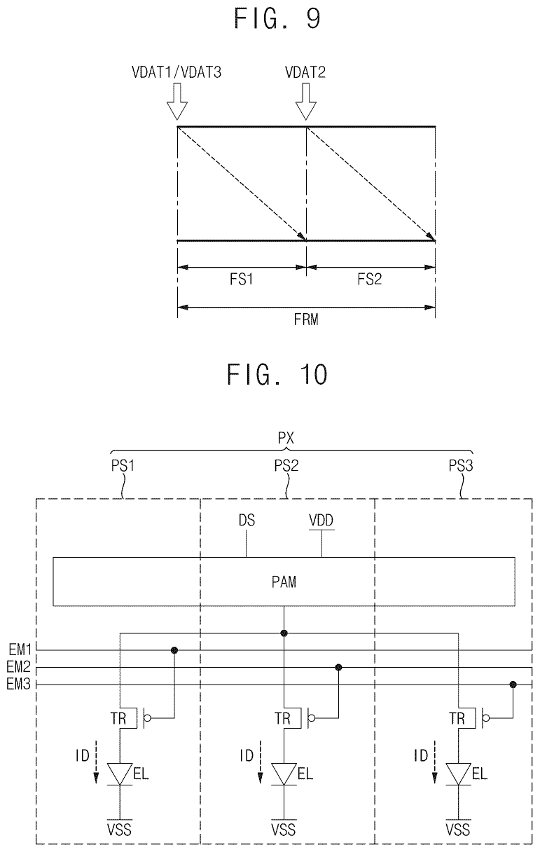

Referring to FIG. 8, a first pixel PX1 may include a first sub-pixel PS1 and a second sub-pixel PS2, and a second pixel PX2 may include a third sub-pixel PS3 and a second sub-pixel PS2. The first pixel PX1 and the second pixel PX2 may display one color by combining a first color displayed by the first sub-pixel PS1, a second color displayed by the second sub-pixels PS2, and a third color displayed by the third sub-pixel PS3. The first sub-pixel PS1 and the second sub-pixel PS2 of the first pixel PX1 may share a same pulse amplitude modulator PAM (i.e., a first pulse amplitude modulator PAM), and the third sub-pixel PS3 and the second sub-pixel PS2 of the second pixel PX2 may share a same pulse amplitude modulator PAM (i.e., a second pulse amplitude modulator PAM). For example, each of the first pixel PX1 and the second pixel PX2 may include one pulse amplitude modulator PAM respectively. Furthermore, each of the light-emitting elements EL may be electrically connected to a line transmitting the low power voltage VSS respectively. FIG. 9 is a schematic view for describing operations of the pixels PX1 and PX2 of FIG. 8.

Referring to FIGS. 8 and 9, a frame period FRM may include a first sub-frame period FS1 and a second sub-frame period FS2. The first sub-pixel PS1 may display the first color in the first sub-frame period FS1, the second sub-pixels PS2 may display the second color in the second sub-frame period FS2, and the third sub-pixel PS3 may display the third color in the first sub-frame period FS1.

A first data voltage VDAT1 and a third data voltage VDAT3 may be applied to the pulse width modulator PWM of the first sub-pixel PS1 and the pulse width modulator PWM of the third sub-pixel PS3, respectively, in the first sub-frame period FS1. A second data voltage VDAT2 may be applied to each of the pulse width modulators PWM of the second sub-pixels PS2 in the second sub-frame period FS2. Accordingly, in the first sub-frame period FS1, a driving current ID having a width W_ID corresponding to the first data voltage VDAT1 may flow through the light-emitting element EL of the first sub-pixel PS1, and a driving current ID having a width W_ID corresponding to the third data voltage VDAT3 may flow through the light-emitting element EL of the third sub-pixel PS3. In the second sub-frame period FS2, a driving current ID having a width W_ID corresponding to the second data voltage VDAT2 may flow through each of the light-emitting elements EL of the second sub-pixels PS2.

FIG. 10 is a schematic view illustrating a pixel PX according to an embodiment. FIG. 11 is a schematic view for describing an operation of the pixel PX of FIG. 10.

Descriptions of components of the pixel PX described with reference to FIGS. 10 and 11, which are substantially equal or similar to those of the pixel PX described with reference to FIGS. 2 and 4, will be omitted.

Referring to FIGS. 3, 10, and 11, each of the first sub-pixel PS1, the second sub-pixel PS2, and the third sub-pixel PS3 may include a light-emitting element EL and a transistor TR. Each of the light-emitting elements EL may be electrically connected to a line transmitting the low power voltage VSS respectively. Furthermore, in the first sub-pixel PS1, the transistor TR may be electrically connected to a first emission signal EM1. In the second sub-pixel PS2, the transistor TR may be electrically connected to a second emission signal EM2. In the third sub-pixel PS3, the transistor TR may be electrically connected to a third emission signal EM3.

The transistor TR may control a width W_ID of a driving current ID in response to emission signals EM1, EM2, and EM3. The gate signal GS of FIG. 1 may include the emission signals EM1, EM2, and EM3. The transistor TR may include a gate receiving the emission signals EM1, EM2, and EM3, a first terminal electrically connected to a pulse amplitude modulator PAM, and a second terminal electrically connected to the light-emitting element EL. The gate of the transistor TR of the first sub-pixel PS1 may receive the first emission signal EM1, the gate of the transistor TR of the second sub-pixel PS2 may receive the second emission signal EM2, and the gate of the transistor TR of the third sub-pixel PS3 may receive the third emission signal EM3.

The pulse amplitude modulator PAM may receive a data signal DS for controlling an amplitude A_ID of the driving current ID. The data signal DS may include a first data voltage VDAT1, a second data voltage VDAT2, and a third data voltage VDAT3.

The pulse amplitude modulator PAM may be electrically connected to a line transmitting the high power voltage VDD, the light-emitting element EL may be electrically connected to a line transmitting the low power voltage VSS, and the transistor TR may be electrically connected between the pulse amplitude modulator PAM and the light-emitting element EL.

As depicted in FIG. 11. in a first sub-frame period FS1, the first data voltage VDAT1 may be applied to the pulse amplitude modulator PAM, and the first emission signal EM1 may have a turn-on voltage level. Accordingly, in the first sub-frame period FS1, a driving current ID having an amplitude A_ID corresponding to the first data voltage VDAT1 may flow through the light-emitting element EL of the first sub-pixel PS1.

In a second sub-frame period FS2, the second data voltage VDAT2 may be applied to the pulse amplitude modulator PAM, and the second emission signal EM2 may have a turn-on voltage level. Accordingly, in the second sub-frame period FS2, a driving current ID having an amplitude A_ID corresponding to the second data voltage VDAT2 may flow through the light-emitting element EL of the second sub-pixel PS2.

In a third sub-frame period FS3, the third data voltage VDAT3 may be applied to the pulse amplitude modulator PAM, and the third emission signal EM3 may have a turn-on voltage level. Accordingly, in the third sub-frame period FS3, a driving current ID having an amplitude A_ID corresponding to the third data voltage VDAT3 may flow through the light-emitting element EL of the third sub-pixel PS3.

A width of a period in which the first emission signal EM1 has a turn-on voltage level, a width of a period in which the second emission signal EM2 has a turn-on voltage level, and a width of a period in which the third emission signal EM3 has a turn-on voltage level may be substantially the same. For example, a width W_ID of the driving current ID flowing through the light-emitting element EL of the first sub-pixel PS1 in the first sub-frame period FS1, a width W_ID of the driving current ID flowing through the light-emitting element EL of the second sub-pixel PS2 in the second sub-frame period FS2, and a width W_ID of the driving current ID flowing through the light-emitting element EL of the third sub-pixel PS3 in the third sub-frame period FS3 may be substantially the same.

FIG. 12 is a schematic view illustrating a pixel PX according to an embodiment.

Descriptions of components of the pixel PX described with reference to FIG. 12, which are substantially equal or similar to those of the pixel PX described with reference to FIG. 10, will be omitted.

Referring to FIG. 12, each of the light-emitting elements EL may be electrically connected to a line transmitting the high power voltage VDD respectively, the pulse amplitude modulator PAM may be electrically connected to a line transmitting the low power voltage VSS, and the transistor TR may be electrically connected between the light-emitting element EL and the pulse amplitude modulator PAM. Furthermore, in the first sub-pixel PS1, the transistor TR may be electrically connected to a first emission signal EM1. In the second sub-pixel PS2, the transistor TR may be electrically connected to a second emission signal EM2. In the third sub-pixel PS3, the transistor TR may be electrically connected to a third emission signal EM3.

FIG. 13 is a schematic view illustrating pixels PX1 and PX2 according to an embodiment.

Descriptions of components of the pixels PX1 and PX2 described with reference to FIG. 13, which are substantially the same as or similar to those of the pixel PX described with reference to FIG. 10, will be omitted. Each of the light-emitting elements EL may be electrically connected to a line transmitting the low power voltage VSS respectively. In the first sub-pixel PS1 of the first pixel PX1, the transistor TR may be electrically connected to a first emission signal EM1, and in the second sub-pixel PS2 of the first pixel PX1, the transistor TR may be electrically connected to a second emission signal EM2. Similarly, in the third sub-pixel PS3 of the second pixel PX2, the transistor TR may be electrically connected to the first emission signal EM1, and in the second sub-pixel PS2 of the second pixel PX2, the transistor TR may be electrically connected to the second emission signal EM2.

Referring to FIG. 13, each of the gate of the transistor TR of the first sub-pixel PS1 and the gate of the transistor TR of the third sub-pixel PS3 may receive the first emission signal EM1, and each of the gates of the transistors TR of the second sub-pixels PS2 may receive the second emission signal EM2.

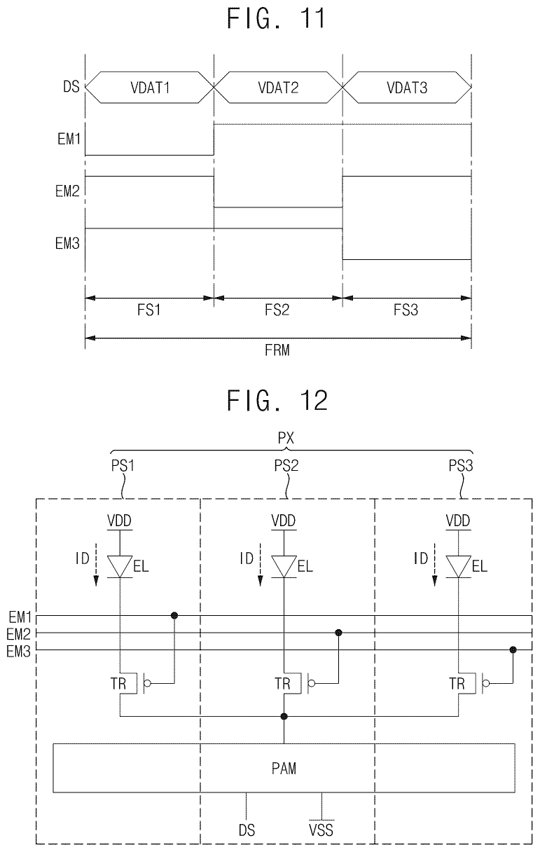

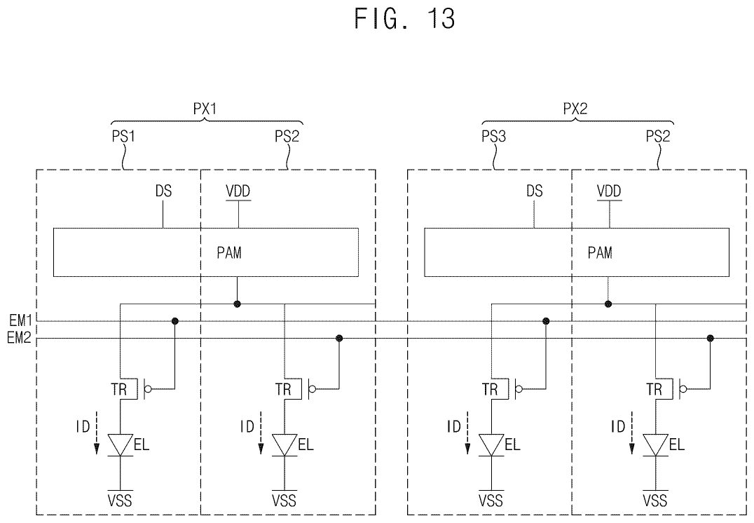

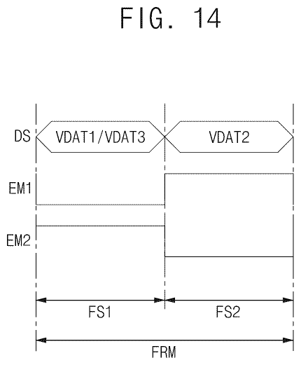

FIG. 14 is a schematic view for describing operations of the pixels PX1 and PX2 of FIG. 13.

Descriptions of steps of an operation of the pixels PX1 and PX2 described with reference to FIG. 14, which are substantially equal or similar to those of the pixels PX1 and PX2 described with reference to FIG. 9 and those of the pixel PX described with reference to FIG. 11, will be omitted.

Referring to FIGS. 13 and 14, in a first sub-frame period FS1, a first data voltage VDAT1 may be applied to the pulse amplitude modulator PAM of the first pixel PX1, a third data voltage VDAT3 may be applied to pulse amplitude modulator PAM of the second pixel PX2, and the first emission signal EM1 may have a turn-on voltage level. Accordingly, in the first sub-frame period FS1, a driving current ID having an amplitude A_ID corresponding to the first data voltage VDAT1 may flow through the light-emitting element EL of the first sub-pixel PS1, and a driving current ID having an amplitude A_ID corresponding to the third data voltage VDAT3 may flow through the light-emitting element EL of the third sub-pixel PS3.

In a second sub-frame period FS2, a second data voltage VDAT2 may be applied to the pulse amplitude modulator PAM of each of the first pixel PX1 and the second pixel PX2, and the second emission signal EM2 may have a turn-on voltage level. Accordingly, in the second sub-frame period FS2, a driving current ID having an amplitude A_ID corresponding to the second data voltage VDAT2 may flow through each of the light-emitting elements EL of the second sub-pixels PS2.

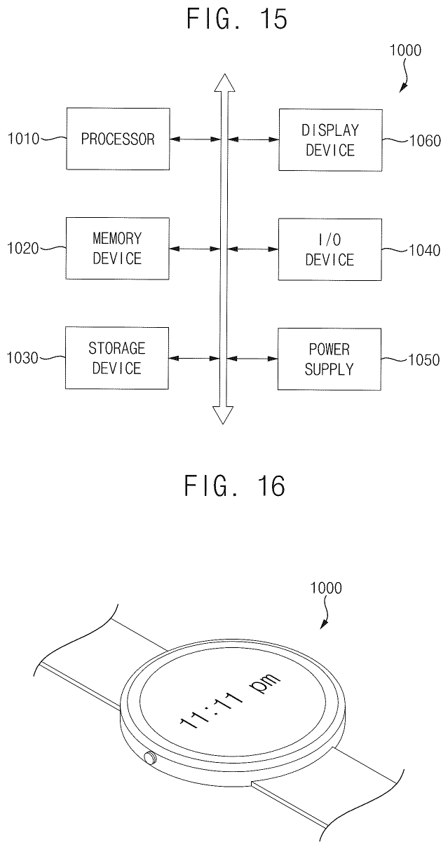

FIG. 15 is a schematic block diagram illustrating an electronic apparatus 1000 according to an embodiment. FIG. 16 is a schematic view illustrating an example in which the electronic apparatus 1000 of FIG. 15 is implemented as a smart watch.

Referring to FIGS. 15 and 16, an electronic apparatus 1000 may include a processor 1010, a memory device 1020, a storage device 1030, an input/output (I/O) device 1040, a power supply 1050, and a display device 1060. The electronic apparatus 1000 may further include multiple ports capable of communicating with a video card, a sound card, a memory card, a USB device, and the like, or communicating with other systems.

As shown in FIG. 16, the electronic apparatus 1000 may be implemented as a smart watch. However, the disclosure is not limited thereto, and according to another embodiment, the electronic apparatus 1000 may be implemented as a television, a mobile phone, a video phone, a smart pad, a tablet PC, a vehicle navigation, a laptop computer, a head-mounted display, or the like.

The processor 1010 may perform specific calculations or tasks. For example, the processor 1010 may be a microprocessor, a central processing unit (CPU), or the like. The processor 1010 may be electrically connected to other components through an address bus, a control bus, a data bus, and the like. For example, the processor 1010 may also be electrically connected to an expansion bus such as a peripheral component interconnect (PCI) bus. The processor 1010 may provide the first image data (IDAT of FIG. 1) and the control signal (CNT of FIG. 1) to the display device 1060.

The memory device 1020 may store data required for an operation of the electronic apparatus 1000. For example, the memory device 1020 may include: a nonvolatile memory device such as an erasable programmable read-only memory (EPROM), an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM); and/or a volatile memory device such as a dynamic random access memory (DRAM), a static random access memory (SRAM), or a mobile DRAM.

The storage device 1030 may include a solid state drive (SSD), a hard disk drive (HDD), a CD-ROM, and the like. The I/O device 1040 may include: an input device such as a keyboard, a keypad, a touch pad, a touch screen, or a mouse; and an output device such as a speaker or a printer. The power supply 1050 may supply a power required for the operation of the electronic apparatus 1000. The display device 1060 may be electrically connected to other components through the buses or other communication links. The display device 1060 may correspond to the display device 100 of FIG. 1.

In a pixel included in the display device 1060, sub-pixels included in the pixel may share a pulse amplitude modulator so that a size of the pixel may be reduced. Further, as the size of the pixel is reduced, the resolution of the display device 1060 may increase.

The display device according to the embodiments may be applied to a display device included in a computer, a notebook, a mobile phone, a smart phone, a smart pad, a smart watch, a PMP, a PDA, an MP3 player, or the like.

In concluding the detailed description, those skilled in the art will appreciate that many variations and modifications may be made to the embodiments without substantially departing from the principles and spirit and scope of the disclosure. Therefore, the disclosed embodiments are used in a generic and descriptive sense only and not for purposes of limitation.

What is claimed is:

1. A pixel, comprising:
a first sub-pixel which displays a first color; and
a second sub-pixel which displays a second color, wherein
each of the first sub-pixel and the second sub-pixel includes:
a light-emitting element through which a driving current flows; and
a pulse width modulator which controls a width of the driving current, and
the first sub-pixel and the second sub-pixel share a pulse amplitude modulator which controls an amplitude of the driving current.

2. The pixel of claim 1, wherein
a frame period includes a first sub-frame period and a second sub-frame period,
the first sub-pixel displays the first color in the first sub-frame period, and
the second sub-pixel displays the second color in the second sub-frame period.

3. The pixel of claim 2, wherein
a first data voltage is applied to the pulse width modulator of the first sub-pixel in the first sub-frame period, and
a second data voltage is applied to the pulse width modulator of the second sub-pixel in the second sub-frame period.

4. The pixel of claim 1, wherein the pulse width modulator includes:
a first transistor including a gate to receive a scan signal, a first terminal to receive a data voltage, and a second terminal electrically connected to a first node;
a capacitor including a first terminal to receive a sweep signal and a second terminal electrically connected to the first node;
a second transistor including a gate electrically connected to a second node, a first terminal electrically connected to the pulse amplitude modulator, and a second terminal electrically connected to the light-emitting element; and
an inverter electrically connected between the first node and the second node.

5. The pixel of claim 1, wherein the pulse amplitude modulator includes a current source.

6. The pixel of claim 1, wherein
the pulse amplitude modulator is electrically connected to a line which transmits a high power voltage,
the light-emitting element is electrically connected to a line which transmits a low power voltage, and
the pulse width modulator is electrically connected between the pulse amplitude modulator and the light-emitting element.

7. The pixel of claim 1, wherein
the light-emitting element is electrically connected to a line which transmits a high power voltage,
the pulse amplitude modulator is electrically connected to a line which transmits a low power voltage, and
the pulse width modulator is electrically connected between the light-emitting element and the pulse amplitude modulator.

8. The pixel of claim 1, further comprising:
a third sub-pixel which displays a third color, wherein
the third sub-pixel includes the light-emitting element and the pulse width modulator, and
the first sub-pixel, the second sub-pixel, and the third sub-pixel share the same pulse amplitude modulator.

9. The pixel of claim 8, wherein
a frame period includes a first sub-frame period, a second sub-frame period, and a third sub-frame period,
the first sub-pixel displays the first color in the first sub-frame period,
the second sub-pixel displays the second color in the second sub-frame period, and
the third sub-pixel displays the third color in the third sub-frame period.

10. The pixel of claim 9, wherein
a first data voltage is applied to the pulse width modulator of the first sub-pixel in the first sub-frame period,
a second data voltage is applied to the pulse width modulator of the second sub-pixel in the second sub-frame period, and
a third data voltage is applied to the pulse width modulator of the third sub-pixel in the third sub-frame period.

11. A pixel, comprising:
a first sub-pixel which displays a first color; and
a second sub-pixel which displays a second color, wherein
each of the first sub-pixel and the second sub-pixel includes:
a light-emitting element through which a driving current flows; and
a transistor which controls a width of the driving current in response to an emission signal, and
the first sub-pixel and the second sub-pixel share a pulse amplitude modulator which controls an amplitude of the driving current.

12. The pixel of claim 11, wherein
a frame period includes a first sub-frame period and a second sub-frame period,
the first sub-pixel displays the first color in the first sub-frame period, and
the second sub-pixel displays the second color in the second sub-frame period.

13. The pixel of claim 12, wherein
a first data voltage is applied to the pulse amplitude modulator in the first sub-frame period, and
a second data voltage is applied to the pulse amplitude modulator in the second sub-frame period.

14. The pixel of claim 11, wherein the transistor includes:
a gate to receive the emission signal,
a first terminal electrically connected to the pulse amplitude modulator, and
a second terminal electrically connected to the light-emitting element.

15. The pixel of claim 11, wherein
the pulse amplitude modulator is electrically connected to a line which transmits a high power voltage,
the light-emitting element is electrically connected to a line which transmits a low power voltage, and
the transistor is electrically connected between the pulse amplitude modulator and the light-emitting element.

16. The pixel of claim 11, wherein
the light-emitting element is electrically connected to a line which transmits a high power voltage,
the pulse amplitude modulator is electrically connected to a line which transmits a low power voltage, and
the transistor is electrically connected between the light-emitting element and the pulse amplitude modulator.

17. A display device, comprising:
a plurality of pixels, each of the plurality of pixels including a first sub-pixel which displays a first color and a second sub-pixel which displays a second color, wherein
each of the first sub-pixel and the second sub-pixel includes:
a light-emitting element through which a driving current flows; and
a pulse width modulator which controls a width of the driving current, and
the first sub-pixel and the second sub-pixel share a pulse amplitude modulator which controls an amplitude of the driving current.

18. The display device of claim 17, wherein
a frame period includes a first sub-frame period and a second sub-frame period,
the first sub-pixel displays the first color in the first sub-frame period, and
the second sub-pixel displays the second color in the second sub-frame period.

19. The display device of claim 18, wherein
a first data voltage is applied to the pulse width modulator of the first sub-pixel in the first sub-frame period, and
a second data voltage is applied to the pulse width modulator of the second sub-pixel in the second sub-frame period.

20. The display device of claim 17, wherein the pulse width modulator includes:
a first transistor including a gate to receive a scan signal, a first terminal to receive a data voltage, and a second terminal electrically connected to a first node;
a capacitor including a first terminal to receive a sweep signal and a second terminal electrically connected to the first node;
a second transistor including a gate electrically connected to a second node, a first terminal electrically connected to the pulse amplitude modulator, and a second terminal electrically connected to the light-emitting element; and
an inverter electrically connected between the first node and the second node.
